(19) United States
(12) Patent Application Publication
(10) Pub. No.: US 2021/0355564 A1
(43) Pub. Date: Nov. 18, 2021

(54) NICKEL-BASED SUPERALLOYS

(71) Applicants: AUBERT & DUVAL, Paris (FR); SAFRAN, Paris (FR)

(72) Inventors: Philippe BELAYGUE, Moissy-Cramayel (FR); Daniel André Jean CORNU, Moissy-Cramayel (FR); Coraline CROZET, Orcines (FR); Rémi GIRAUD, Moissy-Cramayel (FR); Zéline HERVIER, Moissy-Cramayel (FR); Baptiste Romain LARROUY, Moissy-Cramayel (FR); Charlotte MAYER, Clermont Ferrand (FR); Jacques MONTAGNON, La Varenne (FR)

(21) Appl. No.: 17/273,971

(22) PCT Filed: Sep. 13, 2019
(86) PCT No.: PCT/FR2019/052137

§ 371 Date: Mar. 5, 2021

(30) Foreign Application Priority Data
Sep. 13, 2018 (FR) 1858223

(51) Int. Cl. C22C 19/05; B33Y 10/00; B33Y 40/10; B33Y 70/00; B22F 10/28; B22F 10/64; B22F 9/08; C22C 1/04; C22F 1/08; B23K 26/342

(52) U.S. Cl. CPC C22C 19/056; B33Y 10/00; B33Y 40/10; B33Y 70/00; B22F 10/28; B33Y 80/00; B22F 9/082; C22C 1/0433; C22F 1/08; B23K 26/342; B22F 10/64

(57) ABSTRACT

The present invention relates to a nickel-based superalloy with a high γ′ phase content, intended for the manufacture of components by additive manufacturing followed by heat treatment, characterized in that its composition comprises, in percentages by weight of the total composition: Cr: 15.5-16.5; Co: 7.7-11; Mo+W=5.5-7.5; Al: 2.9-4.3; Ti: 2.6-3.2; Ta: 1.5-2.2; Nb: 0.3-1.1; C: 0.01-0.13; B: 0.0005-0.015; Zr: 0.01; Hf: 0.0001-0.5; Si: ≤0.06; Ni: balance, and also the unavoidable impurities.

It further relates to a method for manufacturing superalloy powder and turbine components.

The present invention relates to the field of nickel-based superalloys for high-temperature application, suitable more particularly for the manufacture of components by additive manufacturing, which are intended, for example, for aircraft engine turbines, gas turbines and/or marine industry turbines.

Nickel-based superalloys are the most highly performing materials currently used for the manufacture of the hot components of aerospace jet engines, because their compositions provide them with high mechanical strength at high temperature. The two main features required of these alloys to date, for these specific applications, are therefore high creep resistance at temperatures of possibly up to 1050° C.-1100° C., and very good hot corrosion resistance. One such superalloy is described for example by U.S. Pat. No. 3,459,545 as having the following composition in % by weight:

15-18 Cr, 8-11 Co, 0.75-2.2 Mo, 1.8-3 W, 3-4 Al, 3-4 Ti, 0.5-2 Nb, 1-3 Ta, 0.1-0.2 C, 0.01-0.05 B, 0.01-0.2 Zr, balance Ni and the unavoidable impurities.

Of all the superalloys described in this patent only one, the alloy known by the designation Inconel® 738 LC (IN738LC), has been commercialized for the jet engine components application. This is the reference alloy which is most commonly used in this sector, especially for the manufacture of components such as flow straighteners.

This superalloy therefore has the following composition in % by weight:

15.7-16.3 Cr, 8-9 Co, 1.5-2 Mo, 2.4-2.8 W, 3.2-3.7 Al, 3.2-3.7 Ti, 0.6-1.1 Nb, 1.5-2 Ta, 0.09-0.13 C, 0.007-0.012 B, 0.03-0.08 Zr, max. 0.3 Si, balance Ni and the unavoidable impurities.

The ambitious objectives set for aerospace gas turbines, in terms of increase in yield and decrease in specific consumption, have a great influence on the design of the engines and tend to increase continually the temperatures and the stresses under which the various materials are used, especially those of the nickel-based superalloys. This entails the development of new designs for the hot parts of the engines, for which additive manufacturing methods are particularly appropriate.

Nickel-based superalloys are materials having a basic matrix of γ austenitic nickel (face-centered cubic, hence relatively ductile), this matrix being reinforced with hardening γ′ precipitates (of structure L12) coherent with the matrix, meaning that they have a very similar atomic lattice to the latter. In order to obtain better performance for these superalloys, it is advantageous to strengthen the amounts of γ′ phase they contain at the service temperatures. Superalloys of this kind, however, have a tendency to develop microcracks and/or macrocracks, especially during the additive manufacturing step or in subsequent heat treatment steps. Microcracks are cracks which appear at the time of additive deposition, and macrocracks are cracks which appear during heat treatment. This nomenclature comes from the fact that microcracks are generally substantially smaller than macrocracks, but does not rule out the microcracks having a size comparable with that of the macrocracks.

Patent application WO 2015/096980 A1 describes a nickel-based superalloy composition having a high γ′ hardening phase content, in which the Zr and/or Si content has been lowered (0.004≤Zr<0.03 and 0.001≤Si<0.03 in % by weight, more particularly having a maximum Si content of 0.02 and/or a maximum Zr content of 0.02) and having a particle size of less than 150 μm, in order to be able to use it in an additive manufacturing process such as selective laser melting or electron beam laser melting.

This composition exhibits a decreased propensity to microcracking during additive manufacturing on a powder bed. However, the reduction in the Zr and Si content does not solve the problem of the macrocracks associated with cooling after melting by the laser and with the heat treatment after additive manufacturing. Nor does it lead to an easier heat treatment by modifications to composition.

The article by R. Engeli et al. (Journal of Materials Processing Technology 229 (2016) 484-491) also teaches that the Si content has a great influence on the cracking resistance of nickel-based superalloy compositions of IN738LC type. However, in spite of the very good results of reduction in the density of cracks in the rough lasered component with the reduction in the Si content, this material does not solve the problem of the macrocracks associated with cooling after melting with a laser and with heat treatment after additive manufacturing. Nor does it lead to an easier heat treatment by modifications to composition.

The article by P. Wangyao et al. (Advanced Materials Research Vols 1025-1026 (2014), 395-402) aims to improve the microstructure and the hardness of IN738C (which corresponds to Inconel® 738 having higher carbon contents than IN738LC, presently 0.17%) by adding Al and modifying the solution temperature. However, the increase solely in the Al content, without modification to the rest of the alloy composition (which in any case has an excessively high Nb content of 2%, which is beyond the standard range) gives rise to an increase in precipitation of the γ′ phase.

In this study, the substantial increase in the hardness of the alloy with addition of Al, after heat treatment, is associated with the increased γ′ precipitate content, which could have very harmful consequences in terms of cracking on a crude lasered component, and is not desirable for the applications.

The inventors therefore realized, surprisingly, that in order to obtain a nickel-based superalloy component by additive manufacturing that exhibited fewer macrocracks even after heat treatment after manufacture, and having mechanical characteristics equivalent to those of Inconel® 738 LC, it was necessary to increase the molybdenum and/or tungsten content, more particularly the molybdenum and tungsten content, of the superalloy composition used.

Furthermore, they realized that in order to obtain a nickel-based superalloy component by additive manufacturing that additionally exhibited fewer microcracks, even after heat treatment after manufacture, and having mechanical characteristics equivalent to those of Inconel® 738 LC, it was necessary not only to reduce the zirconium content and possibly the silicon content, but also to reduce the titanium, niobium, and carbon contents of the superalloy composition used.

The reason is that the addition of molybdenum and tungsten, which are heavy elements primarily present in the austenitic matrix, will on the one hand strengthen the matrix and on the other hand slow down the precipitation of the hardening γ′ phase.

Furthermore, a direct effect of decreasing the titanium and niobium contents is to lower the ratio (Ti+Nb+Ta)/Al and so to reduce the hardening character of the γ′ phase. The reduction in titanium content also gives rise to a drop in the γ′ solvus temperature and hence in the proportion of γ′ at a given temperature. Reducing carbon and niobium will, for their part, decrease the proportion of NbC carbides formed during solidification, in the additive manufacturing step. These two modifications to composition (lowering Ti and Nb and lowering C and Nb) have the purpose of limiting the microcracking associated with the micro segregation and with the precipitation of γ′ and of NbC in the additive manufacturing step.

It is indeed true that patent application WO 2015/096980 A1 describes a nickel-based superalloy composition having a Ti content of 2.2-3.7, which may therefore be very low.

However, the skilled person appreciates that this is an obvious error, since this document likewise indicates a Ti content for IN738LC of 2.2-3.7, which is not the standard content (3.2-3.7), and that this document does not at any point teach that a low Ti content is important in order to prevent cracking. Moreover, a limit lower than 2.2 will greatly lower the γ′ solvus temperature and will therefore risk limiting the service temperature of the material, which is certainly not a desired effect.

The present invention therefore relates to a nickel-based superalloy having a high γ′ phase content for the manufacture of components by additive manufacturing followed by heat treatment, characterized in that its composition comprises, advantageously consists essentially of, more particularly consists of, in percentages by weight of the total composition:

chromium: 15.5-16.5;

cobalt: 7.7-11, advantageously 7.7-9;

molybdenum and tungsten such that the molybdenum+tungsten content=5.5-7.5, advantageously 6.2-7.5;

aluminum: 2.9-4.3, advantageously 3-4;

titanium: 2.6-3.2, advantageously 2.6-3.1;

tantalum: 1.5-2.2;

niobium: 0.3-1.1, advantageously 0.3-0.5;

carbon: 0.01-0.13, advantageously 0.01-0.07;

boron: 0.0005-0.015;

zirconium: ≤0.01, advantageously ≤0.009;

hafnium: 0.0001-0.5, advantageously 0.0001-0.2;

silicon: ≤0.06, advantageously ≤0.03;

nickel: balance

and also the unavoidable impurities.

Therefore, in % by weight relative to the total weight of the composition, the composition according to the invention comprises chromium (Cr) in an amount in the range 15.5-16.5, in particular 15.5-16.0, more particularly 15.5-15.8.

It is necessary for the hot corrosion resistance. It is located preferably in the γ phase and participates in the hardening thereof to a solid solution.

The chromium content is measured with an uncertainty of ±0.3, more particularly ±0.2, advantageously ±0.15.

The composition according to the invention further comprises, in % by weight relative to the total weight of the composition, cobalt (Co) in an amount in the range 7.7-11, in particular 7.7-9, more particularly 7.7-8.5.

It participates in the hardening of the γ phase, in which it is located, to a solid solution, and influences the solution temperature of the γ′ phase (γ′ solvus temperature). A high cobalt content will lower the solvus temperature of the γ′ phase and facilitate the homogenization of the alloy by heat treatment without carrying any risk of causing burning. Moreover, a low cobalt content will increase the solvus temperature of the γ′ phase, and enables a greater stability of the γ′ phase to be obtained at high temperature, this being beneficial for the creep resistance. It is therefore appropriate to select a good tradeoff between high homogenization facility and high creep resistance.

The cobalt content is measured with an uncertainty of ±0.2, more particularly ±0.1, advantageously ±0.06.

The composition according to the invention further comprises, in % by weight relative to the total weight of the composition, molybdenum (Mo) and tungsten (W) in a molybdenum+tungsten content in the range of 5.5-7.5, advantageously 5.7-7.5, more advantageously 6-7.5, more particularly 6.2-7.5.

In one advantageous embodiment, the molybdenum (Mo) content of the composition according to the invention, in % by weight relative to the total weight of the composition, is in the range 2.5-3.5, advantageously 2.7-3.5, more particularly 2.7-3.0.

The reason is that molybdenum takes part in the hardening of the γ phase, in which it is located. It will also slow down diffusion into the γ phase, thus giving rise to a retardation of precipitation of γ′.

The molybdenum content is thus increased relative to the standard IN738LC in order to strengthen the γ matrix, while avoiding an excessive proportion, which would have a detrimental effect on the hot corrosion resistance.

The molybdenum content is measured with an uncertainty of ±0.03, more particularly ±0.02, advantageously ±0.01.

In another embodiment, the tungsten (W) content of the composition according to the invention, in % by weight relative to the total weight of the composition, is in the range 3-4, in particular 3.5-4, more particularly 3.6-4.

The tungsten is distributed relatively equally between the two γ and γ′ phases, and hence contributes to the hardening of the two phases by solid solution. Similarly to the Mo, its presence in the alloy makes it possible to slow down diffusion and so to retard the precipitation of γ′. However, too great an amount has a negative effect on the hot corrosion resistance.

The tungsten content is therefore increased relative to the standard IN738LC in order to strengthen the γ matrix. However, it brings about a fairly large decrease in the solidus, without modifying the γ′ solvus. It is therefore necessary to limit the increase thereof, in order to avoid risks of burning during the solution of γ′.

The tungsten content is measured with an uncertainty of ±0.04, more particularly ±0.02, advantageously ±0.01.

In a further embodiment, the molybdenum (Mo) content of the composition according to the invention, in % by weight relative to the total weight of the composition, is in the range 2.5-3.5, advantageously 2.7-3.5, more particularly 2.7-3.0, and the tungsten (W) content of the composition according to the invention, in % by weight relative to the total weight of the composition, is in the range 3-4, in particular 3.5-4, more particularly 3.6-4.

The composition according to the invention further comprises, in % by weight relative to the total weight of the composition, aluminum (Al) in an amount in the range 2.9-4.3, advantageously 3-4, particularly 3.1-3.8.

The Al content has a direct effect on the γ′ solvus temperature and hence on the proportion of γ′ at a given temperature. A fairly low amount may prevent the cracking associated with the precipitation of γ′, by reducing the proportion of the latter, whereas a large amount enables an increase in the proportion of γ′ while lessening its hardening character. Via the Al content it is possible to maintain a high proportion of γ′ (size and distribution) while removing the risk of cracking during heat treatment. The aluminum content is measured with an uncertainty of ±0.04, more particularly ±0.02, advantageously ±0.01.

The composition according to the invention additionally comprises, in % by weight relative to the total weight of the composition, titanium (Ti) in an amount in the range 2.6-3.2, advantageously 2.6-3.1.

In one particular embodiment, the titanium compound is slightly decreased relative to the content in standard IN738LC. For a constant aluminum content, this has the direct effect of lowering the γ′ solvus temperature and hence the proportion of γ′ at a given temperature, for the purpose of preventing the cracking associated with the precipitation of γ′. If the Al content is increased, the proportion of γ′ may be maintained at the level of IN738LC, and the effect of decreasing the ratio (Ti+Ta+Nb)/Al will be to diminish the hardening character of the γ′ phase, thereby removing the risk of cracking associated with the precipitation of γ′.

The titanium content is measured with an uncertainty of ±0.04, more particularly ±0.02.

The composition according to the invention also comprises, in % by weight relative to the total weight of the composition, tantalum (Ta) in an amount in the range 1.5-2.2, advantageously 1.7-2.2.

Tantalum is found in the γ′ phase, in the same way as titanium, and its effect is to strengthen the γ′ phase. The tantalum content is measured with an uncertainty of ±0.02, more particularly ±0.01.

The composition according to the invention further comprises, in % by weight relative to the total weight of the composition, niobium (Nb) in an amount in the range 0.3-1.1, advantageously 0.3-0.8, in particular 0.3-0.6, more particularly 0.3-0.5.

In one advantageous embodiment, the Nb content is lowered relative to the standard content of IN738LC, with the aim of reducing the precipitation of carbides. The small size of the grains obtained from additive manufacturing gives rise to a reduced need for carbides, which may themselves be sources of cracking on cooling.

The niobium content is measured with an uncertainty of ±0.005, more particularly ±0.002.

The composition according to the invention also comprises, in % by weight relative to the total weight of the composition, carbon (C) in an amount in the range 0.01-0.13, advantageously 0.01-0.09, in particular 0.01-0.07, more particularly 0.01-0.05, more particularly still 0.01-0.03.

In one advantageous embodiment, the carbon content is lowered relative to the standard content of IN738LC, with the aim of reducing the precipitation of carbides. The small size of the grains obtained from additive manufacturing gives rise to a reduced need for carbides, which may themselves be sources of cracking on cooling.

The carbon content is measured with an uncertainty of ±0.003, more particularly ±0.002.

The composition according to the invention additionally comprises, in % by weight relative to the total weight of the composition, boron (B) in an amount in the range 0.0005-0.015, more particularly 0.0005-0.005.

In one advantageous embodiment, the boron content is lowered relative to the standard content of IN738LC, with the aim of limiting the existence of the final eutectic system γ/TiB₂, which has a tendency to bring down the solidus and which increases the risk of liquation of borides during the additive manufacturing step.

The boron content is measured with an uncertainty of about 20%.

The composition according to the invention further comprises, in % by weight relative to the total weight of the composition, a zirconium (Zr) content ≤0.01, advantageously ≤0.009, in particular <0.004, more particularly ≤0.003, more particularly still ≤0.0001.

The zirconium content is thus lowered relative to the standard content of IN738LC, with a consequent beneficial effect on the liquation cracking and on the hot cracking occurring during the additive manufacturing step.

The zirconium content is measured with an uncertainty of about 20%.

The composition according to the invention additionally comprises, in % by weight relative to the total weight of the composition, hafnium (Hf) in an amount in the range 0.0001-0.5, advantageously 0.0001-0.2, more advantageously 0.0003-0.2, in particular 0.1-0.5, more particularly 0.1-0.2.

Via the hafnium content it is possible to compensate for the harmful effect of the decrease in Zr on the temperature strength (creep and corrosion in particular).

The hafnium content is measured with an uncertainty of about 20%.

The composition according to the invention also comprises, in % by weight relative to the total weight of the composition, a silicon (Si) content ≤0.06, advantageously ≤0.03, in particular ≤0.025, more particularly ≤0.021.

The silicon content is thus lowered relative to the standard content of IN738LC, with a consequent beneficial effect on the liquation cracking and on the hot cracking occurring during the additive manufacturing step.

The silicon content is measured with an uncertainty of about 20%.

Therefore, in order to suppress the incidence of microcracks and to reduce or even, advantageously, suppress the appearance of macrocracks, the nickel-based superalloy composition according to the invention comprises:
a zirconium content and advantageously silicon content which is lowered relative to the standard content of IN738LC, with a consequent beneficial effect on the liquation cracking and therefore on the hot cracking occurring during the additive manufacturing step.
advantageously a titanium and/or niobium content which is slightly reduced relative to the content of standard IN738LC, with the consequent direct effect of lowering the γ′ solvus temperature and therefore the proportion of γ′ at a given temperature and at constant aluminum content, and of reducing the hardening character of the γ′ phase at a maintained proportion, with the aim of suppressing cracking associated with the precipitation of γ′.
hafnium in order to compensate for the reduction in zirconium, since such reduction has a detrimental effect on the thermal creep resistance.
advantageously an Nb and C content which is lowered relative to the standard content of IN738LC, with the aim of reducing the precipitation of carbides. The small size of the grains obtained from additive manufacturing gives rise to a reduced need for carbides, which themselves may be sources of microcracking during additive manufacturing.
an Mo and/or W content increased relative to the standard content of IN738LC, with the aim of slowing down the rates of diffusion and of lowering the disruptive γ′ forming elements, and also of strengthening the γ matrix in order to reduce drastically the incidence of macrocracks on heat treatment.

Accordingly, in one particularly advantageous embodiment, the nickel-based superalloy according to the present invention is characterized in that its composition comprises, advantageously in that it consists essentially of, more particularly consists of, in percentages by weight of the total composition:

chromium: 15.5-16.5;

cobalt: 7.7-9;

molybdenum and tungsten such that the molybdenum+tungsten content=6.2-7.5;

aluminum: 3-4;

titanium: 2.6-3.1;

tantalum: 1.5-2.2;

niobium: 0.3-0.5;

carbon: 0.01-0.07;

boron: 0.0005-0.005;

zirconium: ≤0.009;

hafnium: 0.0001-0.2;

silicon: ≤0.03;

nickel: balance

and also the unavoidable impurities.

The unavoidable impurities originate from steps in manufacture of the powder, or from impurities present in the starting materials used for manufacturing the powder. All of the conventional impurities encountered in nickel-based superalloys are found. They are selected more particularly from the group consisting of nitrogen, oxygen, hydrogen, lead, sulfur, phosphorus, iron, manganese, copper, silver, bismuth, platinum, selenium, tin, magnesium, and mixtures thereof. They may account for up to 0.15% by mass of the alloy, and represent each not more than 0.05% by weight of the total composition. Generally speaking, the amount of the impurities in the alloy is measured with an uncertainty of 20%.

The nitrogen (N) content in % by weight relative to the total weight of the composition may thus be 0.030, advantageously ≤0.008, in particular ≤0.006, more particularly ≤0.005, more advantageously ≤0.002.

Via the limitation on the nitrogen content it is possible to limit the presence of nitrides or carbonitrides in the component after lasering, as these may be detrimental to certain mechanical properties. The nitrogen content is measured with an uncertainty of ±0.0008, more particularly ±0.0004.

The oxygen (O) content in % by weight relative to the total weight of the composition may thus be 0.030. Such oxygen contents may appear surprising with regard to the conventional processes, but the fractionation of the metal in powder form gives rise to a very high surface/volume ratio, which will tend to greatly increase the oxygen content of the alloy. This oxygen content will increase all the more if the method for manufacturing the powders is not sufficiently controlled. Within this limit of 0.03%, the oxygen may have a beneficial part to play with regard to the hot ductility. Via the limitation on the oxygen content to 0.03% it is possible to limit the presence of oxides in the component after lasering, since these are detrimental to the mechanical properties.

The oxygen content is measured with an uncertainty of ±0.0007, more particularly ±0.0005.

The composition of the powder according to the present invention may more particularly be selected from one of the 3 examples indicated in table 1 below.

TABLE 1
Powder composition examples for nickel-based superalloy in
% by weight relative to the total weight of the composition

| | Example 1 | Example 2 | Example 3 |
|---|---|---|---|
| Ni + | balance | balance | balance |
| impurities | | | |
| Cr | 15.66 ± 0.08 | 15.72 ± 0.24 | 15.78 ± 0.08 |
| Co | 7.81 ± 0.05 | 7.86 ± 0.12 | 8.58 ± 0.06 |
| Mo | 2.84 ± 0.02 | 2.90 ± 0.03 | 2.97 ± 0.03 |
| W | 3.70 ± 0.02 | 3.81 ± 0.04 | 3.80 ± 0.02 |
| Al | 3.74 ± 0.01 | 3.24 ± 0.04 | 3.23 ± 0.01 |
| Ti | 3.01 ± 0.02 | 3.10 ± 0.04 | 3.20 ± 0.02 |
| Ta | 1.85 ± 0.01 | 1.94 ± 0.02 | 1.90 ± 0.01 |
| Nb | 0.778 ± 0.005 | 0.495 ± 0.005 | 0.526 ± 0.005 |
| C | 0.0870 ± 0.0026 | 0.0230 ± 0.0016 | 0.0434 ± 0.0004 |
| B | 0.0140 ± 0.0028 | 0.00056 ± 0.00012 | 0.0044 ± 0.0008 |
| Zr | 0.0078 ± 0.0016 | 0.000098 ± 0.000020 | 0.0008 ± 0.0002 |
| Hf | 0.179 ± 0.001 | 0.00017 ± 0.00004 | 0.00014 ± 0.00003 |
| Si | 0.0250 ± 0.0050 | 0.0210 ± 0.0042 | 0.0280 ± 0.0050 |
| O | 0.0110 ± 0.0007 | 0.0110 ± 0.0007 | 0.0121 ± 0.0001 |
| N | 0.0055 ± 0.0004 | 0.0019 ± 0.0004 | 0.0059 ± 0.0001 |
| S | <0.0005 ± 0.0001 | <0.0005 ± 0.0001 | <0.00067 ± 0.0001 |
| P | 0.000018 ± 0.000004 | 0.0002 ± 0.000004 | 0.00014 ± 0.00001 |

Example 1 comprises an increase in the amounts of Mo and W and a decrease in the Ti content relative to the standard IN738LC. Al is raised to the upper limit of the window of the standard IN738LC. These modifications are aimed, on the one hand, at slowing down the diffusion rates in order to retard the precipitation of γ′ and, on the other, at lowering the hardening character of the γ′ phase. Consequently the γ′ solvus temperature is lowered by 20 to 30° C. relative to IN738LC. It also contains an addition of Hf relative to the standard IN738LC, in order to compensate for the lowering of the Zr relative to the standard IN738LC and for the potential harmful consequences on the creep resistance of the superalloy.

Example 2 comprises, in addition, a reduction in the Nb and C contents relative to the standard IN738LC, in order to reduce the proportion of carbides of Nb and to improve the behavior of the grade on cooling, during additive manufacturing. Moreover, the boron is also lowered, so as to prevent the precipitation of borides at the grain boundaries and to limit as far as possible the phenomena of liquation during the manufacture of components.

Example 3, like example 2, is a working example in accordance with the composition claimed. It differs from example 2 in its B and C contents, which are slightly greater than example 2, in order to confirm the robustness of the claimed window of compositions.

In one advantageous embodiment, the nickel-based superalloy according to the invention takes the form of a powder, advantageously having a particle size distribution (diameter by number) in the range 15-53 μm, more particularly if it is intended for the manufacture of components by selective laser melting (SLM).

Traditionally, for this type of particle size fractions, the lower limit of 15 μm, characterized by the D10 by number, is controlled by laser diffraction (ASTM B822-17), and the upper cutoff of 53 μm is controlled by sieving. The practice of controlling particle size fraction according to the ASTM B214-16 or ISO 2591-1 standard of 1988 in force allows for the control of fractions down to 45 μm by sieving. Below this limit, control by sieving is no longer authorized according to the standard, and characterization is accomplished via the value of the D10 by number of distribution measured by laser diffraction.

In one advantageous embodiment, the nickel-based superalloy according to the invention takes the form of a wire, intended for shaping by wire deposition, according to the various possible processes (by arc, plasma, electron beam, or laser).

The present invention further relates to a method for manufacturing a nickel-based superalloy powder according to the invention, comprising the following steps:

a—mixing elemental or prealloyed starting materials,

b—melting the mixture obtained in step a), advantageously in a vacuum induction furnace (VIM),

c—gas-atomizing the product obtained in step b), advantageously with argon, so as to obtain a powder which, advantageously, is primarily spherical (i.e., with no acute angle),

d—sieving the powder obtained in step c), advantageously under an inert atmosphere, so as to obtain the desired particle size,

e—recovering the resulting powder.

The particle size of the powder is therefore adapted depending on the additive manufacturing technology or the power deposition process that is intended. The particle size ranges used for the various processes of additive manufacturing or of powder deposition vary depending on the technology, the equipment, and the intended applications. Generally speaking, if all of the applications are combined, the powder used for these methods will have more or less wide particle size distributions by number, between 5 and 150 μm.

More particularly, the particle size fraction by number obtained in step d) is in the range 15-53 μm. This is an appropriate particle size for the process of selective laser melting (LBM for Laser Beam Melting), and is compatible with the equipment used and the intended applications. This is a fairly typical particle size distribution by number for this usage of the powder.

The present invention further relates to a method for manufacturing a component, more particularly turbines, in nickel-based superalloy, characterized in that it comprises the following steps:

A—manufacturing the nickel-based superalloy powder according to the present invention, advantageously by means of the method according to the present invention, more particularly as described above,

B—subjecting the powder obtained in step A to an additive manufacturing process, advantageously selected from the group consisting of selective laser melting (LBM), electron beam melting (EBM), and laser melting by powder spraying (also called powder coating or CLAD),

C—subjecting the component obtained in step B to at least one thermal and/or physical and/or chemical treatment, advantageously selected from the group consisting of a relaxation heat treatment, more particularly for relaxing residual constraints, a hot isostatic pressing treatment, a solution treatment, an aging treatment, and a finishing treatment such as application of a coating providing protection against corrosion and oxidation, said treatment being advantageously a hot isostatic pressing (HIP) treatment,

D—recovering the resultant component.

The method according to the present invention may further comprise, between steps B and C, a step B1 of welding components obtained with the superalloy according to the present invention.

The methods of additive manufacturing which can be used in the context of the present invention, more particularly such as selective laser melting, electron beam melting, laser melting by powder spraying (powder coating or CLAD), are well known to the skilled person.

In one advantageous embodiment, step B consists of a method of additive manufacturing which comprises the layer-by-layer manufacture of the component via the use of an energy source (laser or electron beam), which melts a thin layer of the superalloy powder according to the invention. A second layer of superalloy powder according to the invention is then deposited and subsequently melted. This method is repeated until the final component is obtained. The method is advantageously one of selective laser melting.

In another embodiment of the method for manufacturing a component, more particularly turbines, in nickel-based superalloy according to the invention, step A consists of manufacturing a wire of nickel-based superalloy according to the present invention, and step B consists of a method of additive manufacturing which comprises the layer-by-layer manufacture of the component through use of an energy source (laser or electron beam), which melts the superalloy wire obtained in step A. One layer is therefore made by melting the continually unwound wire, with the wire being melted as it is unwound. The second layer is formed on the first layer. This method is repeated until the final component is obtained. In a further embodiment of the method for manufacturing a component, more particularly turbines, in nickel-based superalloy according to the invention, step A consists of the manufacture of a power and a wire of nickel-based superalloy according to the present invention, and step B consists of a method of additive manufacturing that uses both the powder and the wire of superalloy.

The present invention additionally relates to a nickel-based superalloy component obtained from the powder and/or the wire according to the present invention and more particularly as described above, advantageously by means of the method according to the present invention and more particularly as described above.

This component is advantageously a 3D component.

More particularly, it is an aircraft engine turbine component, a gas turbine component, or a marine industry turbine component.

It may therefore be a hot part of a turbine, such as a fixed or moving turbine blade, or a turbine disk, examples being aerospace jet engines.

The nickel-based superalloy component according to the present invention advantageously exhibits:
mechanical properties at least equal to those of the standard alloy IN738LC, such as, for example, high thermal creep resistance;
a corrosion and oxidation resistance at least equal to that of the standard alloy IN738LC, such as, for example, high resistance to a saline environment;
the absence of macrocracks and/or of microcracks;
a density similar to that of the standard alloy IN738LC, such as, for example, about 8.1 g/cm³;
a service temperature of possibly up to 1050-1100° C.

The present invention relates, lastly, to the use of the nickel-based superalloy component according to the present invention in aircraft engine turbines, gas turbines, or marine industry turbines, more particularly in the hot parts of the turbines.

The invention will be appreciated more in light of the figures and examples which follow, which are given by way of indication and not of limitation.

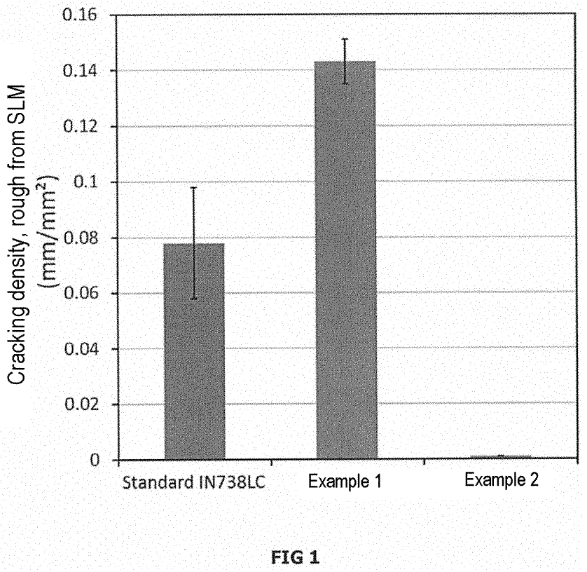

FIG. 1 represents the microcracking density in mm/mm² associated with manufacture by LBM (or SLM), in the rough LBM state, for examples 1 and 2 and for the comparative example (standard IN738LC).

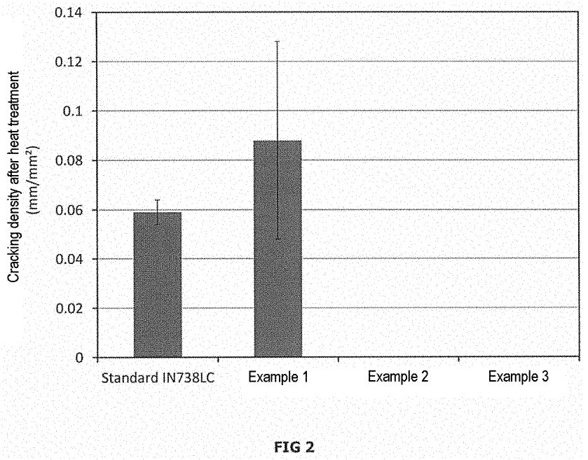

FIG. 2 represents the microcracking density in mm/mm² as measured after manufacture by LBM and heat treatment, in the dissolved and aged state, for examples 1, 2 and 3 and for the comparative example (standard IN738LC).

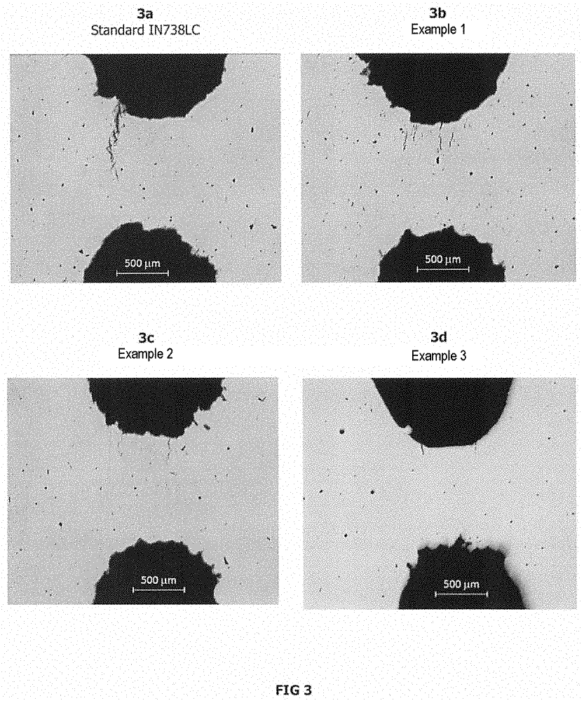

FIG. 3 represents images of macrocracking in the stress concentration zones after heat treatment, as obtained by optical microscopy (Zeiss Axio Imager Atm with Axiocam ICc5) at a resolution of 5 megapixels and a magnification of ×50 after cutting and polishing of the samples (examples 1, 2 and 3 (FIGS. 3b, 3c and 3d, respectively) and comparative example: standard IN738LC (FIG. 3a)).

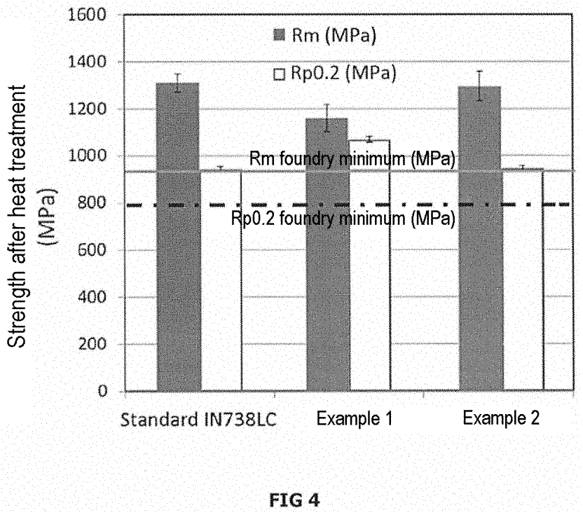

FIGS. 4 and 5 represent the results of tensile tests (strength in MPa: FIG. 4, and elongation E5d in %: FIG. 5) at ambient temperature (according to standard NF EN 2002-001 of 2006) on bars placed in solution and aged, for 3 samples (examples 1 and 2 and comparative example: standard IN738LC) manufactured, along the XY axis (horizontal to the plate).

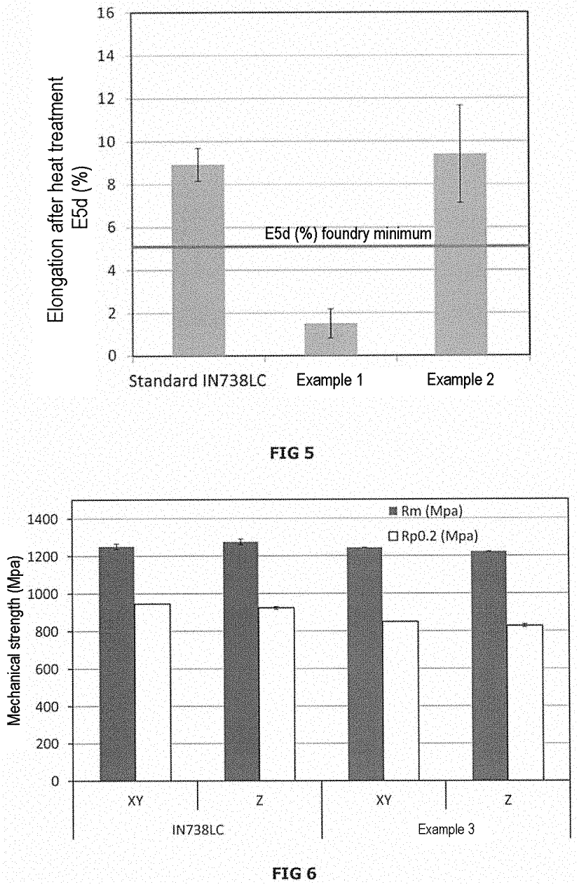

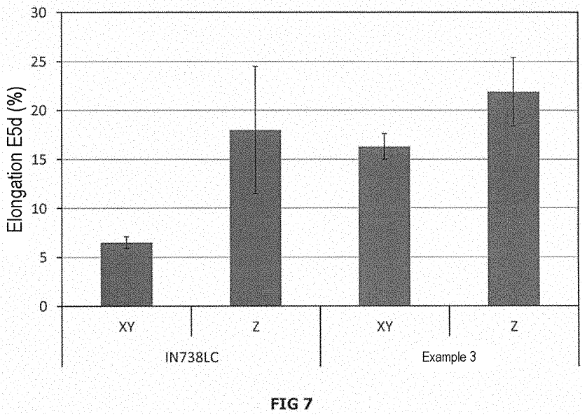

FIGS. 6 and 7 represent the results of tensile tests (strength in MPa: FIG. 6, and elongation E5d in %: FIG. 7) at 650° C. (according to standard NF EN 2002-002) on bars placed in solution and aged, for example 3, and for prior-art data from the comparative example (IN738LC).

### EXAMPLES

Three examples of powders according to the invention, the compositions of which are indicated in table 2 below, were produced from elemental materials in the proportions mastered, in a VIM furnace, and then atomized with argon.

TABLE 2
Powder compositions for nickel-based superalloy in % by
weight relative to the total weight of the composition

| | Example 1 | Example 2 | Example 3 |
|---|---|---|---|
| Ni + | balance | balance | balance |
| impurities | | | |
| Cr | 15.66 ± 0.08 | 15.72 ± 0.24 | 15.78 ± 0.08 |
| Co | 7.81 ± 0.05 | 7.86 ± 0.12 | 8.58 ± 0.06 |
| Mo | 2.84 ± 0.02 | 2.90 ± 0.03 | 2.97 ± 0.03 |
| W | 3.70 ± 0.02 | 3.81 ± 0.04 | 3.80 ± 0.02 |
| Al | 3.74 ± 0.01 | 3.24 ± 0.04 | 3.23 ± 0.01 |
| Ti | 3.01 ± 0.02 | 3.10 ± 0.04 | 3.20 ± 0.02 |
| Ta | 1.85 ± 0.01 | 1.94 ± 0.02 | 1.90 ± 0.01 |
| Nb | 0.778 ± 0.005 | 0.495 ± 0.005 | 0.526 ± 0.005 |
| C | 0.0870 ± 0.0026 | 0.0230 ± 0.0016 | 0.0434 ± 0.0004 |
| B | 0.0140 ± 0.0028 | 0.00056 ± 0.00012 | 0.0044 ± 0.0008 |
| Zr | 0.0078 ± 0.0016 | 0.000098 ± 0.000020 | 0.0008 ± 0.0002 |
| Hf | 0.179 ± 0.001 | 0.00017 ± 0.00004 | 0.00014 ± 0.00003 |
| Si | 0.0250 ± 0.0050 | 0.0210 ± 0.0042 | 0.0280 ± 0.0050 |
| O | 0.0110 ± 0.0007 | 0.0110 ± 0.0007 | 0.0121 ± 0.0001 |
| N | 0.0055 ± 0.0004 | 0.0019 ± 0.0004 | 0.0059 ± 0.0001 |
| S | <0.0005 ± 0.0001 | <0.0005 ± 0.0001 | <0.00067 ± 0.0001 |
| P | 0.000018 ± 0.000004 | 0.0002 ± 0.00004 | 0.00014 ± 0.00001 |

As well as the lowering of the Zr, Si, S, and P contents, which has been shown to benefit the behavior on additive manufacturing, the 3 following axes of improvement of the composition with regard to its capacity for additive manufacturing and for heat treatment, have been demonstrated: the reduction in Ti and Nb so as to reduce the hardness of the γ′ phase, and/or in Nb and C in order to reduce the precipitation of the NbC carbides, both with the aim of reducing the propensity to microcracking during the additive manufacturing step; the increase in the amount of Mo and W, so as to slow down the precipitation of γ′ and strengthen the matrix in order to reduce the propensity to macrocracking during the heat treatment. Thus, example 1 comprises an increase in the amounts of Mo and W relative to the standard IN738LC, with the standard amounts otherwise and with secondary elements reduced to the lowest level. Examples 2 and 3 are similar to example 1 (increase in Mo and W), with, in addition, a reduction in the amounts of Nb and C relative to the standard IN738LC. Otherwise they have standard amounts and secondary elements reduced to the lowest level. Example 1 contains, as well, an addition of Hf relative to the standard IN738LC, in order to compensate for the reduction in Zr relative to the standard IN738LC and for the potential harmful consequences on the creep resistance of the superalloy. A comparative, reference example of IN738LC powder obtained by atomizing an IN738LC ingot acquired from the company Brami was manufactured. The method is as follows: the ingot was melted in a VIM furnace and then atomized with argon.

Table 3 below presents the composition of the comparative, reference example.

TABLE 3
Composition of the comparative, reference example IN738LC in
% by weight relative to the total weight of the composition

| Ni + | balance |
|---|---|
| impurities | |
| Cr | 16.21 ± 0.37 |
| Co | 8.63 ± 0.20 |
| Mo | 1.85 ± 0.04 |
| W | 2.70 ± 0.06 |
| Al | 3.44 ± 0.05 |
| Ti | 3.40 ± 0.06 |
| Ta | 1.88 ± 0.06 |
| Nb | 0.88 ± 0.02 |
| C | 0.0990 ± 0.0030 |
| B | 0.0200 ± 0.0040 |
| Zr | 0.0130 ± 0.00026 |
| Hf | < detection limit |
| Si | 0.0290 ± 0.0058 |
| O | 0.0085 ± 0.0005 |
| N | 0.0046 ± 0.0009 |
| S | <0.0005 ± 0.0001 |
| P | 0.00076 ± 0.00015 |

In the rough state from atomization, the 3 examples according to the invention and the comparative examples have a wider particle size distribution than the particle size distribution intended for the application (presently SLM or LBM). They were therefore sieved to 15 and 53 μm under an inert atmosphere so as to isolate the 15-53 μm particle size fraction, which the skilled person knows to be particularly suitable for SLM (or LBM) application. The chemical analyses presented in tables 2 and 3 were carried out on the final powders after sieving.

The resultant powders (examples 1, 2 and 3 and comparative example) were used for manufacturing technological test specimens representative of the application, and tensile test blanks with dimensions of 13 mm×13 mm×70 mm, by EOS M290 LBM additive manufacturing, with a layer thickness of 40 μm and a laser power of 250-370 W; the separation of the resultant blanks from the manufacturing plate by electrical discharge, followed by the standard heat treatment of the IN738LC alloy, which involves bringing the alloy into solution at 1120° C. (subsolvus conditions) for 2 h, followed by air cooling, then aging at 845° C. for 24 h, followed by air cooling, before machining of the blanks according to the test specimen geometries corresponding to the test standards for tensile tests under ambient conditions (NF EN 2002-001) and at 650° C. (NF EN 2002-002) and for the creep/rupture tests (NF EN 2002-005).

Microcracking

The microcrack density in mm/mm² was measured by analysis of images taken with an optical microscope with a magnification of ×50 on the rough technological test specimens after additive manufacturing and after heat treatment in the solution state (at 1120° C. for 2 h, followed by air cooling) and aged (at 845° C. for 24 h, followed by air cooling), and the results are set out, respectively, in FIGS. 1 and 2 for examples 1 and 2 and the comparative example and example 3. The total length of cracks observed is expressed relative to the surface area of material in question.

The reference sample (comparative example, standard IN738LC) allows the state-of-the-art IN738LC to be located at a microcrack density of about 0.08 mm/mm². Example 2, with the reductions in Nb and C, clearly prevents microcracking during the additive manufacturing step, with identical LBM parameters.

The values measured in FIG. 2 after heat treatment are a little lower than those measured on rough material from manufacture (FIG. 1), but they remain entirely suitable and the samples are different. Again there are the standard IN738LC and example 1, which exhibit microcracks, whereas examples 2 and 3 do not suffer cracking. This is entirely consistent with the data obtained on rough material from LBM.

Macrocracking

As illustrated in FIG. 3, the sample produced with reference IN738LC exhibits a macrocrack in the stress zone, which is directly associated with the loss of ductility of the alloy during the mass precipitation of γ′ phase during solution. Examples 1, 2 and 3, with an increase in the amounts of Mo and W relative to the standard IN738LC of about 50% to 60% and 35% to 40%, respectively, exhibit a drastic reduction in the macrocracking after heat treatment. The procedure of slowing down the precipitation of the γ′ phase and the strengthening of the γ matrix do indeed allow the objective to be attained of reducing the cracks during heat treatment.

Table 4 summarizes the various improvement strategies claimed for reducing the microcracking and the macrocracking, and their apportionment between the three examples presented, and shows that the coordination of the strategies of anti-microcracking (reduction in a) Nb and Ti or in b) Nb and C, and reduction in the elements Zr, Si, S and P) and of anti-macrocracking (increase in the amounts of Mo and W) is particularly advantageous for obtaining a material which is sound after manufacture by LBM followed by a solution heat treatment and aging.

TABLE 4
Matrix of the improvements provided in the various examples and
associated results in terms of microcracking and macrocracking

| | Example 1 | Example 2 | Example 3 |
|---|---|---|---|
| Reduction in | X | X | X |
| Zr, Si, S, P | | | |
| Reduction in | | X | X |
| Nb and C | | | |
| Increase in | X | X | X |
| Mo and W | | | |
| Results | Microcracking | Microcracking | Microcracking |
| | present | absent | absent |
| | Very slight | Very slight | Very slight |
| | macrocracking in | macrocracking in | macrocracking in |
| | the stress | the stress | the stress |
| | concentration | concentration | concentration |
| | zone | zone | zone |

It should be noted, moreover, that the inventors tested a comparative example 1 comprising solely a reduction in the amounts of Ti and Nb relative to the standard IN738LC, but without any increase in Mo and W. This comparative example showed the presence of macrocracks in the stress concentration zone after heat treatment.

Tensile Tests

Observed in FIGS. 4 and 5 is a relative stability in mechanical strength (Rm and Rp 0.2) of examples 1 and 2 in relation to the reference IN738LC, and values which all very greatly exceed the specification for foundry IN738LC. The elongation of example 2 is greater than that of the reference IN738LC, whereas the elongation of example 1, which is very greatly affected by microcracking, is impaired. Lastly, the reference batch, example 2, is beyond the specification of foundry IN738LC. Its mechanical properties are therefore not impaired following these modifications to composition.

FIGS. 6 and 7 present the results of tensile tests at 650° C. for example 3 and for a series of tests carried out on the comparative example (standard IN738LC), which constitutes the state-of-the-art, standard alloy shaped by laser melting on a powder bed, as a function of the axis of manufacture of the components (XY: horizontal axis on plate, Z: vertical axis on plate). The test specimens in question underwent a subsolvus solution treatment, and there is no recrystallization and no growth in the metallurgical grains obtained during solidification. These grains therefore remain highly oriented according to the axis of manufacture of the components (Z axes), and their morphology is dependent on the manufacturing parameters used. The properties are of the same order in the two directions of manufacture, with minor differences which can be explained by differences in LBM parametrics.

Creep/Rupture Tests

The lifetimes obtained by the creep/rupture tests under extreme conditions (760° C./585 MPa) on test specimens manufactured according to the Z axis (vertical relative to the plate) or the XY axis (horizontal relative to the plate) for example 3 and the comparative example (IN738LC) are presented in tables 5 and 6 below.

TABLE 5
Mean lifetime and standard deviation in creep/rupture
at 760° C./585 MPa for example 3

| Orientation | Number of specimens | Lifetime (h) |
|---|---|---|
| XY | 5 | 4.7 ± 0.7 |
| Z | 5 | 12.9 ± 1.1 |

TABLE 6
Mean lifetime in creep/rupture at 760° C./585 MPa for IN738LC

| Orientation | Lifetime (h) |
|---|---|
| XY | 0.03 |
| Z | 2.5 |

The two materials are situated within similar lifetime ranges, with example 3 being slightly superior to IN738LC.

1. A nickel-based superalloy with high γ′ phase content, intended for the manufacture of components by additive manufacturing followed by heat treatment, characterized in that its composition comprises, in percentages by weight of the total composition:
chromium: 15.5-16.5;
cobalt: 7.7-11;
molybdenum and tungsten such that the molybdenum+tungsten content=5.5-7.5;
aluminum: 2.9-4.3;
titanium: 2.6-3.2;
tantalum: 1.5-2.2;
niobium: 0.3-1.1;
carbon: 0.01-0.13;
boron: 0.0005-0.015;
zirconium: ≤0.01;
hafnium: 0.0001-0.5;
silicon: ≤0.06;
nickel: balance
and also unavoidable impurities.

2. The nickel-based superalloy as claimed in claim 1, wherein its composition comprises, in percentages by weight of the total composition:
chromium: 15.5-16.5;
cobalt: 7.7-9;
molybdenum and tungsten such that the molybdenum+tungsten content=6.2-7.5;
aluminum: 3-4;
titanium: 2.6-3.1;
tantalum: 1.5-2.2;
niobium: 0.3-0.5;
carbon: 0.01-0.07;
boron: 0.0005-0.005;
zirconium: ≤0.009;
hafnium: 0.0001-0.2;
silicon: ≤0.03;
nickel: balance
and also unavoidable impurities.

3. The nickel-based superalloy as claimed in claim 1, wherein its molybdenum content is 2.5-3.5, in percentages by weight of the total composition.

4. The nickel-based superalloy as claimed in claim 1, wherein its tungsten content is 3-4, in percentages by weight of the total composition.

5. The nickel-based superalloy as claimed in claim 1, wherein the unavoidable impurities are selected from the group consisting of nitrogen, oxygen, hydrogen, lead, sulfur, phosphorus, iron, manganese, copper, silver, bismuth, platinum, selenium, tin, magnesium, and mixtures thereof.

6. The nickel-based superalloy as claimed in claim 1, wherein:
its nitrogen content ≤0.030% and
its oxygen content ≤0.030%.

7. The nickel-based superalloy as claimed in claim 1, which is in the form of powder.

8. The nickel-based superalloy as claimed in claim 1, which is in the form of wire.

9. A method for manufacturing the nickel-based superalloy powder as claimed in claim 7, comprising the following steps:
a—mixing elemental or prealloyed starting materials,
b—melting the mixture obtained in step a),
c—gas-atomizing the product obtained in step b),
d—sieving the powder obtained in step c) so as to obtain the desired particle size,
e—recovering the resulting powder.

10. A method for manufacturing a component, from nickel-based superalloy, comprising the following steps:
A—manufacturing the nickel-based superalloy powder as claimed in claim 7,
B—subjecting the powder obtained in step A to an additive manufacturing process,
C—subjecting the component obtained in step B to at least one thermal and/or physical and/or chemical treatment,
D—recovering the resultant component.

11. The method as claimed in claim 10, wherein step B is a selective laser melting (LBM).

12. A nickel-based superalloy component obtained from the nickel-based superalloy as claimed in claim 1.

13. The component as claimed in claim 12, which is free of macrocracks.

14. Aircraft engine turbines, gas turbines, terrestrial turbines, or marine industry turbines containing the nickel-based superalloy component as claimed in claim 12.

15. The method as claimed in claim 10, wherein step B is selected from the group consisting of selective laser melting (LBM), electron beam melting (EBM), and laser melting by powder spraying (CLAD).

16. The method as claimed in claim 10, wherein step C is selected from the group consisting of a relaxation heat treatment, a hot isostatic pressing treatment, a solution treatment, an aging treatment, and a finishing treatment.

17. The method as claimed in claim 10, wherein step C is a hot isostatic pressing treatment.

18. The component as claimed in claim 12, which is free of macrocracks and of microcracks.

19. The method as claimed in claim 9, wherein step b is carried out in a vacuum induction furnace.

20. The method as claimed in claim 9, wherein step c is carried out with argon.
